(19) United States
(12) Patent Application Publication
(10) Pub. No.: US 2010/0197276 A1
(43) Pub. Date: Aug. 5, 2010

(54) METHOD OF REGISTERING A TELEPHONE DIRECTORY IN A MOBILE PHONE AND THE MOBILE PHONE

(75) Inventor: Tomoki Furuya, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku, Tokyo (JP)

(21) Appl. No.: 12/671,122

(22) PCT Filed: Aug. 6, 2008
(86) PCT No.: PCT/JP2008/064120

§ 371 Date: Jan. 28, 2010

(30) Foreign Application Priority Data
Aug. 14, 2007 (JP) 2007-211280

(51) Int. Cl. H04M 1/66

(52) U.S. Cl. 455/411

(57) ABSTRACT

A telephone directory registration method in a mobile phone is provided which is capable of preventing damage caused by nuisance mails and of supporting the individual content of registration that differs for each different for each different model of a mobile phone. It is determined whether or not an electronic mail received from another mobile phone is electronic mail that is to be registered in a telephone directory. If so, it is determined whether or not the originating address of the electronic mail is an address which is permitted to be registered in a telephone directory. If so, the content of said electronic mail to be registered is registered in the telephone directory of the mobile phone, provided that the content of the electronic mail is in accordance with a telephone directory registration format.

### TECHNICAL FIELD

The present invention relates to a mobile phone, and more particularly to a method of registering a telephone directory in a mobile phone.

### BACKGROUND OF THE INVENTION

When registering a telephone directory in a mobile phone, it is customary that one pushes input keys of the mobile phone to enter data in accordance with the registration format of the telephone directory of the mobile phone. However, there are users who are unable to register a telephone directory because entry through key inputs is difficult for them, and there are users who feel that entry through key inputs in a mobile phone is harder that entry from a keyboard in a personal computer. When the former users register a telephone directory, they need to ask anyone else to do it. But in this case, it is essential that the former users hand over their mobile phones in which a telephone directory is to be registered, to a person who is asked to register a telephone directory. To this end, Patent document 1 discloses a method wherein a mobile phone in which a telephone directory is to be registered is caused to receive electronic mail containing the content to be registered, and therefore a telephone directory can be registered based on the electronic mail. However, according to the method disclosed in the above patent document, it is likely that the content of a particular kind of subject in electronic mail will be registered in the telephone directory, regardless of the source of the electronic mail, there causing damage to the mobile phone in cases where the mail is nuisance mail. The above method is also problematic in that items of data other than telephone numbers and mail addresses, which are to be registered in the telephone directory of the current mobile phones, cannot be set in the telephone directory based upon the model of a particular mobile phone.
Patent document 1: JP2002-185603A

### DISCLOSURE OF THE INVENTION

### Problems to be Solved by the Invention

It is an object of the present invention to provide a method of registering a telephone directory in a mobile phone, a mobile phone and a recording medium on which a telephone directory registering program is recorded, which are capable of preventing damage due to nuisance electronic mails and also capable of registering a telephone directory even when a the registration format in the telephone directory will be different for each individual mobile phone model.

### Means to Solve the Problems

A method of registering a telephone directory in a mobile phone, according to the present invention, comprises the steps of:

determining whether or not electronic mail received from another mobile phone is electronic mail that is to be registered in the telephone directory;

if said electronic mail is electronic mail that is to be registered in the telephone directory, determining whether or not the originating address of said electronic mail is an address which is permitted to be registered in the telephone directory;

if the originating address of said electronic mail is an address which is permitted to be registered in the telephone directory, determining whether or not the content of said electronic mail is in accordance with the registration format of the telephone directory; and

if the content of said electronic mail is in accordance with the registration format of the telephone directory, registering the content of said electronic mail to be registered in the telephone directory, in the telephone directory of the mobile phone.

A mobile phone according to the present invention comprises:

memory for storing a telephone directory; and

a control means for determining whether or not electronic mail received from another mobile phone is electronic mail that is to be registered in the telephone directory; if said electric mail is electronic mail that is to be registered in the telephone directory, determining whether or not the originating address of said electronic mail is an address which is permitted to be registered in the telephone directory; if the originating address of said electronic mail is an address which is permitted to be registered in the telephone directory, determining whether or not the content of said electronic mail is in accordance with the registration format of the telephone directory; and if the content of said electronic mail is in accordance with the registration format of the telephone directory, registering the content of said electronic mail to be registered in the telephone directory, in the telephone directory that is in the memory.

A computer-readable storage medium storing a telephone directory registration program for causing a computer to perform an operation for registering a telephone directory in a mobile phone, according to the present invention, the telephone directory registration program comprises the procedures of:

determining whether or not electronic mail received from another mobile phone is electronic mail that is to be registered in the telephone directory;

if said electric mail is electronic mail that is to be registered in the telephone directory, determining whether or not the originating address of said electronic mail is an address which is permitted to be registered in the telephone directory;

if the originating address of said electronic mail is an address which is permitted to be registered in the telephone directory, determining whether or not the content of said electronic mail is in accordance with the registration format of the telephone directory; and

if the content of said electronic mail is in accordance with the registration format of the telephone directory, registering the content of said electronic mail to be registered in the telephone directory, in the telephone directory of the mobile phone.

According to the present invention, registering electronic mail (the content of electronic mail) in a telephone directory is performed based on electronic mail that is described in accordance with the registration format of the telephone directory of the mobile phone in which registration in the telephone directory is performed. Therefore, registering content of electric mail in the telephone directory in which said content conforms to items to be registered that are specific to the mobile phone, can be performed even by a person who does not posses a mobile phone in which registration in the telephone directory is to be performed. Furthermore, by registering in advance mail addresses of persons which are permitted to be registered in the telephone directory, only those requests for registration that are made by way of electronic mail from persons whose addresses are permitted to be registered are permitted, thus preventing erroneous registration caused by nuisance electronic mails.

### BRIEF DESCRIPTION OF THE DRAWINGS

FIG. 1 is a block diagram of a mobile phone according to an exemplary embodiment of the present invention.

FIG. 2 is a flow chart illustrating the operation of the mobile phone when it asks another mobile phone to perform a telephone directory registration.

FIG. 3 is a flowchart illustrating the operation of the mobile telephone when the mobile phone receives a telephone directory format from another mobile phone and performs a telephone directory registration.

FIG. 4 is a flowchart illustrating the specific example of a telephone directory registration process.

FIG. 5 is a flowchart illustrating another specific example of a telephone directory registration process.

FIG. 6 is a view illustrating an example of a telephone directory format.

FIG. 7 is a view of an example of the content which is desired to be registered in the telephone directory format.

### EXPLANATION OF SYMBOLS

11 antenna
12 transmission/reception section
13 memory
15 display section
15 operating section
16 control section

101˜106 step

### BEST MODE FOR CARRYING OUT THE INVENTION

Referring to FIG. 1, a mobile phone according to an exemplary embodiment of the present invention comprises antenna 11, transmission/reception section 12, memory 13, display section 14, operating section 15 and control section 16.

Antenna 11 is a section that transmits and receives radio waves. Transmission/reception section 12 is a section that converts a signal to be transmitted to a radio wave and converts a received radio wave to a signal. Memory 13 is a section that stores a telephone directory and mail addresses that are permitted to be registered. Display section 14 is a section that displays a variety of information so that the user may easily understand the information. Operating section 15 is a section that implements operations that the user desires. Control section 16 is a control means that controls each section of the mobile phone, such as display of information on display section 14, start of a telephone conversation, and the like.

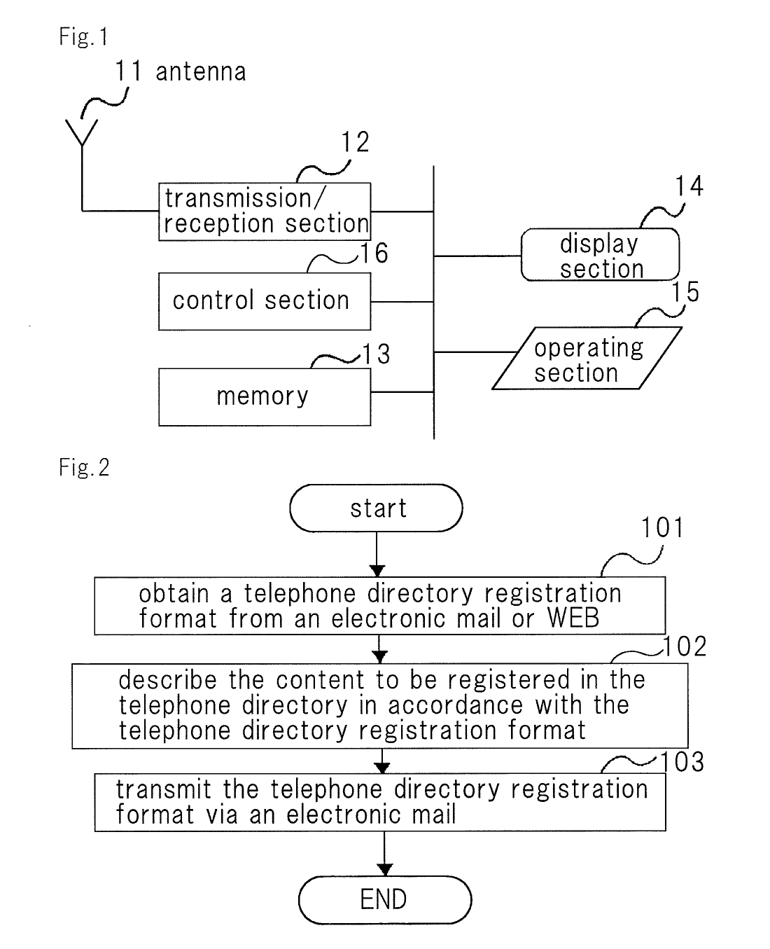

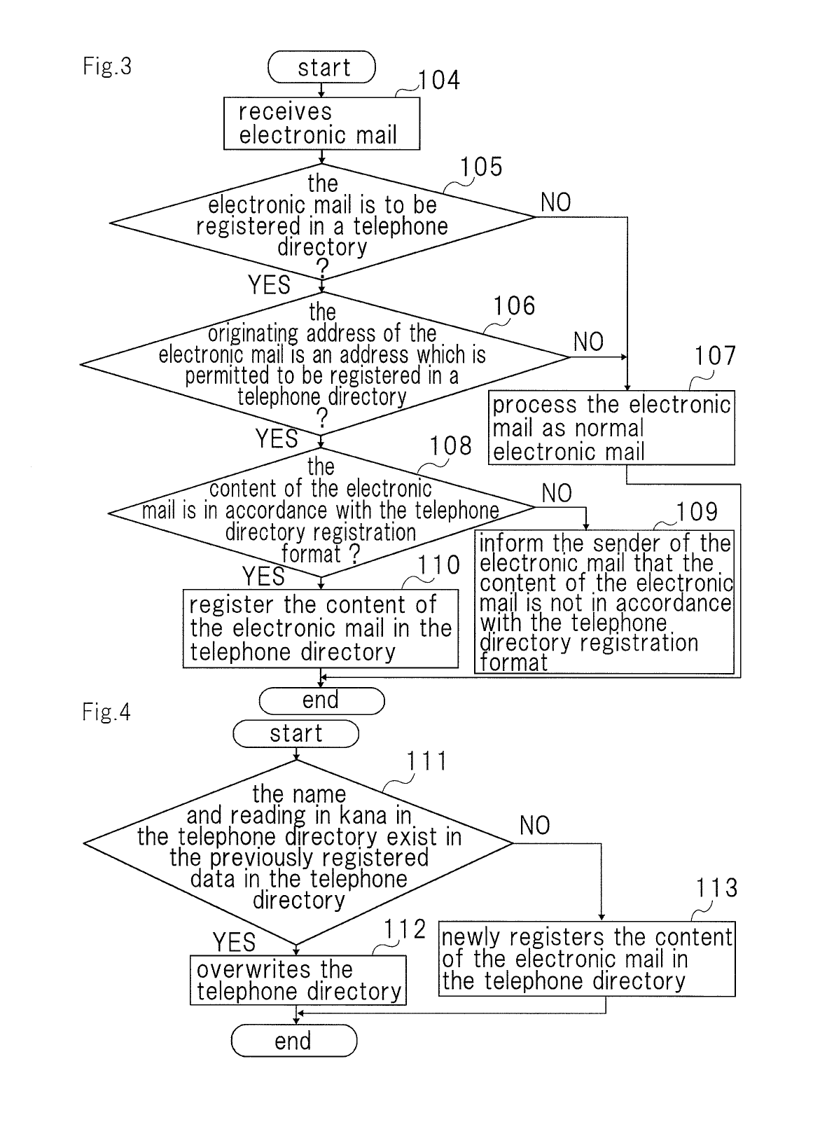

Operation of the present exemplary embodiment of the present invention will next be explained with reference to the flowcharts of FIGS. 2 and 3.

FIG. 2 is a flowchart illustrating the operation of the mobile phone when it asks another mobile phone to perform an operation for registering electronic mail in the telephone directory.

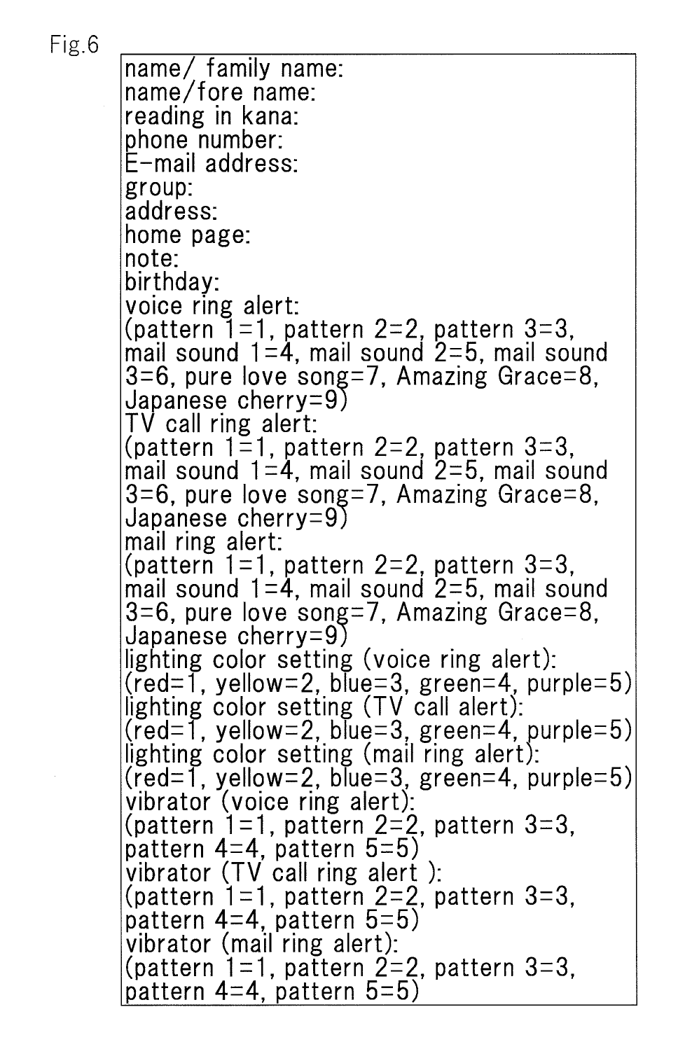

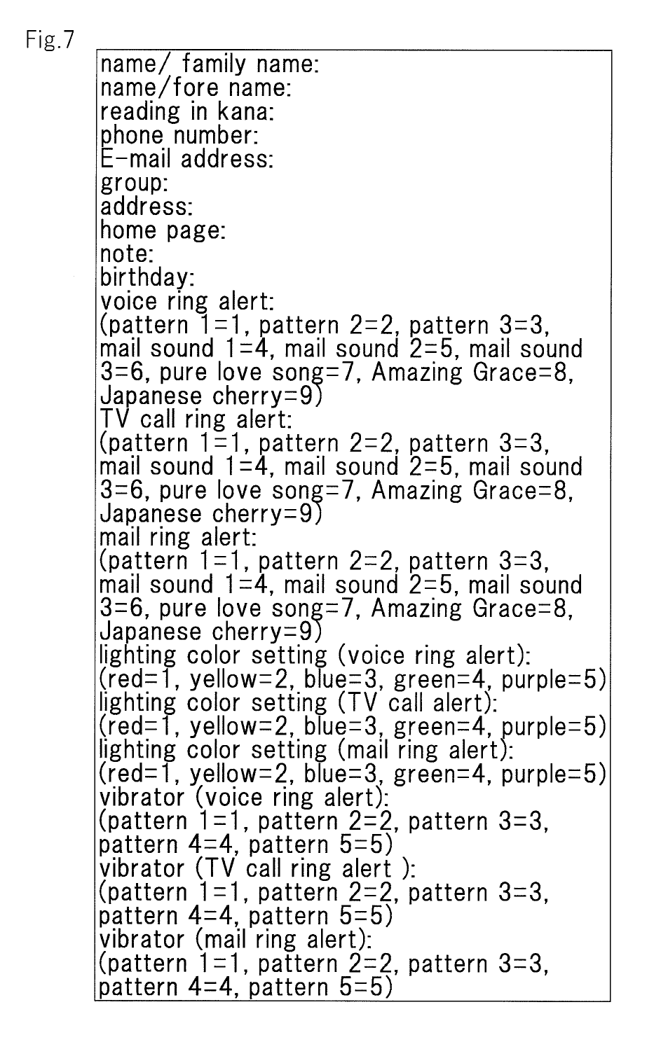

First, at step 101, the user of the mobile phone obtains a registration format of a telephone directory of a mobile telephone in which the user desires to perform an operation for registering electronic mail in the telephone directory. The manner with which to obtain registration format of a telephone directory may include obtaining the format by means of an electronic mail from a mobile phone in which the user desires to perform an operation for registering electronic mail in the telephone directory, and obtaining the format from a Web site of a manufacturer of the mobile phone. FIG. 6 shows by way of example the registration format of the telephone directory. As shown in FIG. 6, the registration format of the telephone directory includes items to be registered in accordance with the telephone directory of the mobile phone. If a telephone call is alerted by a ringing sound, the color of a light, the vibrating pattern of a vibrator etc., the pattern of the alert can be set on the mobile phone based on the individual person who is registered in the telephone directory and on patterns that are described in the telephone directory. Next, at step 102, the content to be registered in the telephone directory is described in accordance with the registration format of the telephone directory that was obtained. FIG. 7 shows by way of example the content that is desired to be registered in the telephone directory format. Thereafter, at step 103, the registration format of the telephone directory thus described is transmitted via an electronic mail to the mobile phone in which the telephone directory is desired to be registered.

FIG. 3 is a flow chart illustrating the operation of the present exemplary embodiment when the mobile phone receives from another mobile phone the registration format of the telephone directory the content of which has been described and performs an operation to register content of the electronic mail in the telephone directory.

First, at step 104, transmission/reception section 12 receives the electronic mail. Next, at step 105, control section 16 determines from the subject of the electronic mail whether or not the received electronic mail is electronic mail that is to be registered in a telephone directory. If the subject of the received electronic mail is not a predetermined subject that indicates that said mail is to be registered in the telephone directory, that is, if the result of determination in step 105 is “NO”, then control section 16 processes the electronic mail received as normal electronic mail. If the subject of the received electronic mail is a predetermined subject that indicates that said mail is to be registered in the telephone directory, that is, if the result of determination in step 105 is “YES”, then at step 106, control section 16 determines whether or not the originating address of the received electronic mail is an address which is permitted to be registered in the telephone directory. If the originating address of the received electronic mail is an address which is not permitted to be registered in the telephone directory, that is, if the result of determination in step 106 is “NO”, then at step 107, control section 16 processes the received electronic mail as normal electronic mail. If the originating address of the received electronic mail is an address which is permitted to be registered in the telephone directory, that is, if the result of determination in step 106 is “YES”, then at step 108, control section 16 determines whether or not the content of the received electronic mail is in accordance with the registration format of the telephone directory. If the content of the received electronic mail is not in accordance with the registration of the telephone directory (for example, when an item(s) which does or do not exist in the registration of the telephone directory of the mobile phone, when an item(s) which should be entered in figures was or were entered in letters), that is, when the result of determination in step 108 is “NO”, then at step 109, control section 16 informs from transmission/reception section 12 the sender of the electronic mail that the registration of electronic mail could not be properly performed, because the content of the electronic mail differs from the registration format of the telephone directory. If the content of the received electronic mail is in accordance with the registration format of the telephone directory, that is, the result of determination in step 108 is “YES”, then at step 110, control section 16 overwrites the telephone directory of the mobile phone that is in memory 13 with the content of said electronic mail to be registered in the telephone directory, or newly registers the content of said electronic mail to be registered in the telephone directory, in the telephone directory in memory 13.

FIG. 4 is a flow chart illustrating a specific example of the step in FIG. 3 of registering electronic mail in the telephone directory. At step 111, control section 16 determines whether or not the name and reading in kana of a person to be registered in the telephone directory exist in the previously registered data of the telephone directory stored in memory 13. If the same data as the name and reading in kana of a person to be registered exist, that is, if the result of determination in step 111 is “YES”, then at step 112, control section 16 overwrites the telephone directory of the mobile phone in memory 13 with the content of the telephone directory to be registered in the received electronic mail. If the same data as the name and reading in kana of a person to be registered do not exist, that is, if the result of determination in step 111 is “NO”, then at step 112, control section 16 newly registers the content of the electronic mail to be registered in the telephone directory, in the telephone directory of the mobile phone.

According to the present exemplary embodiment, by registering a telephone directory only when the received electronic mail is an electronic mail from an address which is previously permitted to be registered, damage due to nuisance mail can be prevented, and by obtaining the registration format of the telephone directory of a mobile phone in which a telephone directory is to be registered, by electronic mail or by way of Web, and by using this format, registration of a telephone directory can be performed even when the registration format of the telephone directory is different for each individual mobile telephone model.

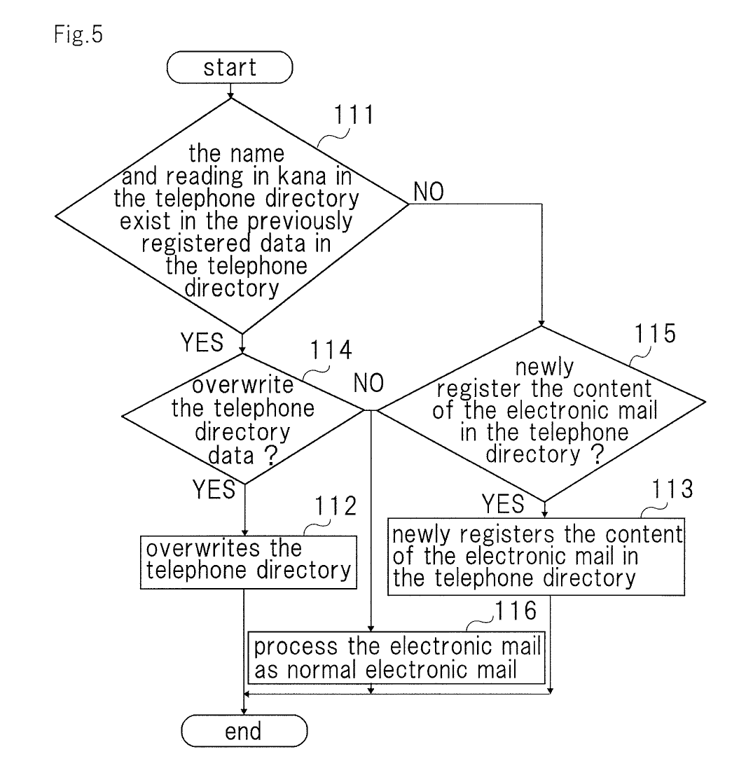

FIG. 5 is a flow chart illustrating another specific example of the step in FIG. 3 of registering electronic mail in the telephone directory.

The example shown in FIG. 4 is configured to show that the completion of the process to register electric mail in a telephone directory without the user of a mobile phone, in which the registration process is performed, quite noticing it. In contrast, the present example is configured such that the user finally determines whether to perform an operation to register electronic mail in the telephone directory, thus ensuring greater security over the registration of the electronic mail in the telephone directory.

At step 111, control section 16 determines whether or not the name and reading in kana of a person to be registered in the telephone directory exist in the previously registered data of the telephone directory. If the same data as the name and reading in kana of a person to be registered exist, that is, the result of determination in step 111 is “YES”, then at step 114, control section 16 displays a message “overwrite the telephone directory data?” on display section 14 which is a screen of the mobile phone. If the user selects “YES”, then at step 112, control section 16 overwrites the telephone directory of the movable phone with the telephone directory data. If the user selects “NO”, then control section 16 does not overwrite the telephone directory of the mobile phone, and at step 116 processes the received electronic mail as normal electronic mail.

At step 111, control section 16 determines whether or not the name and reading in kana of a person to be registered in the telephone directory exist in the previously registered data of the telephone directory stored in memory 13. If the same data as the name and reading in kana of a person to be registered do not exist, that is, if the result of determination in step 111 is “NO”, then at step 112, control section 16 displays the message “newly register the telephone directory?” on display section 14 which is a screen of the mobile phone. If the user selects “YES”, then at step 113, control section 16 newly register the telephone directory of a mobile phone. If the user selects “NO”, then control section 16 does not newly registers the telephone directory, and at step 116, processes the received electronic mail as normal electronic mail.

The functions of control section 16 of the mobile terminal as explained hereinabove may be carried out by recording a program for performing the functions of the processing operation in a computer-readable recording medium, and then by reading the program thus recorded into a computer. The computer-readable recording medium may refer to a recording medium such as a flexible disk, a CD-ROM, or the like, or a recording medium such as a hard disk drive incorporated in a computer system. The computer-readable recording medium may also refer to a medium for dynamically holding a computer program for a short period of time, e.g., a transmission medium or a transmission wave, for use in applications for transmitting the program through the Internet, or a medium for holding the program for a certain period of time, e.g., volatile memory in a computer system which operates as a server in such an application.

This application is based upon and claims the benefit of priority from Japanese patent application No. 2007-211280 filed on Aug. 14, 2007, the disclosure of which is incorporated herein in its entirety by reference.

While preferred exemplary embodiments of the present invention have been described using specific terms, such description is for illustrative purposes only, and it is to be understood that changes and variations may be made without departing from the spirit or scope of the following claims.

1. A method of registering a telephone directory in a mobile phone, comprising:
determining whether or not an electronic mail received from another mobile phone unit is electronic mail that is to be registered a the telephone directory;
if said electric mail is electronic mail that is to be registered in the telephone directory, determining whether or not the originating address of said electronic mail is an address which is permitted to be registered in the telephone directory;
if the originating address of said electronic mail is an address which is permitted to be registered in the telephone directory, determining whether or not the content of said electronic mail is in accordance with the registration format of the telephone directory; and
if the content of said electronic mail is in accordance with the registration format of the telephone directory, registering the content of said electronic mail to be registered in the telephone directory, in the telephone directory of the mobile phone.

2. The method of registering a telephone directory in a mobile phone, according to claim 1, wherein said registering includes:
determining whether or not the name and its reading in kana of a person who is to be registered in the telephone directory exist in the previously registered data of the telephone directory;
if the name and its reading in kana of a person who is to be registered in the telephone directory exist in the previously registered data of the telephone directory, overwriting the telephone directory of the mobile phone with the content of said electronic mail to be registered in the telephone directory; and
if the name and its reading in kana of a person who is to be registered in the telephone directory do not exist in the previously registered data of the telephone directory, newly registering the content of said electronic mail to be registered in the telephone directory, in the telephone directory of the mobile phone.

3. The method of registering a telephone directory in a mobile phone, according to claim 1, wherein said registering includes:
determining whether or not the name and its reading in kana of a person who is to be registered in the telephone directory exist in the previously registered data of the telephone directory;
if the name and its reading in kana of a person who is to be registered in the telephone directory exist in the previously registered data of the telephone directory, displaying on the screen of the mobile phone a message to the user of the mobile phone;
if the user of the mobile phone has made the selection of overwriting the telephone directory of the mobile phone with the content of said electronic mail to be registered in the telephone directory, overwriting the telephone directory of the mobile phone with the content of said electronic mail to be registered in the telephone directory;
if the name and its reading in kana of a person who is to be registered in the telephone directory do not exist in the previously registered data of the telephone directory, displaying on the screen of the mobile phone a message to the user of the mobile phone inquiring whether or not the content of said electronic mail, to be registered in the telephone directory, is newly registered in the telephone directory of the mobile phone; and
if the user of the mobile phone has made the selection of newly registering the content of said electronic mail to be registered in the telephone directory, in the telephone directory of the mobile phone, overwriting the telephone directory of the mobile phone with the content of said electronic mail to be registered in the telephone directory.

4. A mobile phone comprising:
memory for storing a telephone directory; and
a control means for determining whether or not an electronic mail received from another mobile phone unit is electronic mail that is to be registered in a telephone directory; if said electric mail is electronic mail that is to be registered in a telephone directory, determining whether or not the originating address of said electronic mail is an address which is permitted to be registered in a telephone directory; if the originating address of said electronic mail is an address which is permitted to be registered in a telephone directory, determining whether or not the content of said electronic mail is in accordance with the registration format of a telephone directory; and if the content of said electronic mail is in accordance with the registration format of a telephone directory, registering the content of said electronic mail to be registered in a telephone directory, in the telephone directory in said memory.

5. The mobile phone according to claim 4, wherein said registering the content of said electronic mail to be registered in a telephone directory, in the telephone directory in said memory includes:
determining whether or not the name and its reading in kana of a person who is to be registered in the telephone directory exist in the previously registered data of the telephone directory;
if the name and its reading in kana of a person who is to be registered in the telephone directory exist in the previously registered data of the telephone directory, overwriting the telephone directory of the mobile phone with the content of said electronic mail to be registered in the telephone directory; and
if the name and its reading in kana of a person who is to be registered in the telephone directory do not exist in the previously registered data of the phone directory, newly registering the content of said electronic mail to be registered in the telephone directory, in the telephone directory of the mobile phone.

6. The mobile phone according to claim 4, wherein said registering the content of said electronic mail to be registered in a telephone directory, in the telephone directory in said memory includes:
determining whether or not the name and its reading in kana of a person who is to be registered in the telephone directory exist in the previously registered data of the telephone directory;
if the name and its reading in kana of a person who is to be registered in the telephone directory exist in the previously registered data of the telephone directory, displaying on the screen of the mobile phone a message to the user of the mobile phone;
if the user of the mobile telephone has made the selection of overwriting the telephone directory of the mobile phone with the content of said electronic mail to be registered in the telephone directory, overwriting the telephone directory of the mobile phone with the content of said electronic mail to be registered in the telephone directory;
if the name and its reading in kana of a person who is to be registered in the telephone directory do not exist in the previously registered data of the telephone directory, displaying on the screen of the mobile phone a message to the user of the mobile phone inquiring whether or not the content of said electronic mail, to be registered in the telephone directory, is newly registered in the telephone directory of the mobile phone; and
if the user of the mobile telephone has made the selection of newly registering the content of said electronic mail to be registered in the telephone directory, in the telephone directory of the mobile phone, overwriting the telephone directory of the mobile phone with the content of said electronic mail to be registered in the telephone directory.

7. A computer-readable storage medium storing a telephone directory registration program for causing a computer to perform an operation for registering a telephone directory in a mobile phone, said telephone directory registration program comprising the procedures of:
determining whether or not an electronic mail received from another mobile phone unit is electronic mail that is to be registered in a telephone directory;
if said electric mail is electronic mail that is to be registered in a telephone directory, determining whether or not the originating address of said electronic mail is an address which is permitted to be registered in a telephone directory;
if the originating address of said electronic mail is an address which is permitted to be registered in a telephone directory, determining whether or not the content of said electronic mail is in accordance with the registration format of a telephone directory; and
if the content of said electronic mail is in accordance with the registration format of a telephone directory, registering the content of said electronic mail to be registered in a telephone directory, in the telephone directory of the mobile phone.

8. The computer-readable storage medium according to claim 7, wherein said registration procedure includes the procedures of:
determining whether or not the name and its reading in kana of a person who is to be registered in the telephone directory exist in the previously registered data of the telephone directory;
if the name and its reading in kana of a person who is to be registered in the telephone directory exist in the previously registered data of the telephone directory, displaying on the screen of the mobile phone a message to the user of the mobile phone;
if the user of the mobile telephone has made the selection of overwriting the telephone directory of the mobile phone unit with the content of said electronic mail to be registered in the telephone directory, overwriting the telephone directory of the mobile phone with the content of said electronic mail to be registered in the telephone directory;
if the name and its reading in kana of a person who is to be registered in the telephone directory do not exist in the previously registered data of the telephone directory, displaying on the screen of the mobile phone a message to the user of the mobile phone inquiring whether or not the content of said electronic mail, to be registered in the telephone directory, is newly registered in the telephone directory; and
if the user of the mobile telephone has made the selection of newly registering the content of said electronic mail to be registered in the telephone directory, in the telephone directory of the mobile phone, overwriting the telephone directory of the mobile phone with the content of said electronic mail to be registered in the telephone directory.

9. The computer-readable storage medium according to claim 7, wherein said registration procedure includes the procedures of:
determining whether or not the name and its reading in kana of a person who is to be registered in the telephone directory exist in the previously registered data of the telephone directory;
if the name and its reading in kana of a person who is to be registered in the telephone directory exist in the previously registered data of the telephone directory, displaying on the screen of the mobile phone a message to the user of the mobile phone;
if the user of the mobile phone has made the selection of overwriting the telephone directory of the mobile phone with the content of said electronic mail to be registered in the telephone directory, overwriting the telephone directory of the mobile phone with the content of said electronic mail to be registered in the telephone directory;
if the name and its reading in kana of a person who is to be registered in the telephone directory do not exist in the previously registered data of the telephone directory, displaying on the screen of the mobile phone a message to the user of the mobile phone inquiring whether or not the content of said electronic mail, to be registered in the telephone directory, is newly registered in the telephone directory of the mobile phone; and
if the user of the mobile phone has made the selection of newly registering the content of said electronic mail to be registered in the telephone directory, in the telephone directory of the mobile phone, overwriting the telephone directory of the mobile phone with the content of said electronic mail to be registered in the telephone directory.
